(19) United States
(12) Patent Application Publication
(10) Pub. No.: US 2026/0175535 A1
(43) Pub. Date: Jun. 25, 2026

(54) Method for Smoothing and Tensioning a Fabric Cover over a Curved Furniture Frame

(71) Applicant: MOGOGO LTD, Tel Aviv (IL)

(72) Inventors: Yariv KADOSH, Tel Aviv (IL); Mordehay BEN AHARON, Tel Aviv (IL); Amit KAUFMAN, BORGATA (IL)

(73) Assignee: MOGOGO LTD, Tel Aviv (IL)

(21) Appl. No.: 19/541,451

(22) Filed: Feb. 17, 2026

Related U.S. Application Data
(63) Continuation-in-part of application No. 18/800,154, filed on Aug. 12, 2024.

(51) Int. Cl. B32B 5/18; A47G 9/02

(52) U.S. Cl. CPC B32B 5/18; A47G 9/0246; A47G 9/0253

(57) ABSTRACT

A method for smoothing and tensioning a fabric cover over a curved furniture frame to provide a wrinkle-free appearance. The method comprises providing a cover assembly including a fabric sheet with a sleeve and a spring steel strip pre-inserted therein, the strip having a natural bias toward a straight configuration. The assembly is secured to a curved furniture frame via upper and lower connecting means. Tensioning is achieved through the mechanical interference between the straight bias of the spring steel strip and the arcuate geometry of the furniture frame. As the strip attempts to return to its straight configuration, it exerts a continuous outward force that pushes the fabric away from the curved frame, thereby eliminating wrinkles and maintaining the fabric in a smooth, tensioned state regardless of frame irregularities.

### RELATED APPLICATIONS

This application is a continuation in part of U.S. patent application No. 18/800,154 filed on August 12, 2024.

### TECHNICAL FIELD

The present invention relates to a method for smoothing and tensioning a fabric cover over curved furniture frames. More specifically, the invention relates to a method that utilizes the linear bias of a spring steel strip to exert an outward force against an arcuate frame, thereby eliminating wrinkles in the fabric.

### BACKGROUND ART

In the furniture industry, frames are often covered by fabric sheets. When a frame is straight, stretching the sheet to achieve a tight, aesthetic look is relatively simple. However, when the frame is curved (arcuate), standard fabric sheets tend to become loose, wrinkled, and aesthetically unpleasing at the curves.

Prior art solutions often utilize elastic materials, such as rubber bands or bungee cords, to tension fabric. However, such elastic materials work by contraction (pulling inward) and typically follow the contour of the frame. In contrast, the present invention provides a method that utilizes an expansion or "straightening" force to push the fabric away from the curved frame, ensuring a perfectly smooth transition regardless of the frame's specific curvature.

### DESCRIPTION OF THE DRAWINGS

The drawings are intended to illustrate the implementation of the method and do not limit the scope of the invention:

FIG. 1 depicts the curved frame (20) of the furniture (30).

FIG. 2 depicts the spring steel strip (50) used in the method.

FIG. 3 depicts the bottom strip (83) and the bottom connecting means (80).

FIGS. 4 - 6 depict the self-tightening fabric cover assembly (10).

FIG. 7 depicts the result of the method: the fabric cover assembled and tensioned on the frame.

FIG. 8 depicts the connection of the bottom connecting means (80).

FIG. 9 depicts the upper connecting means (60).

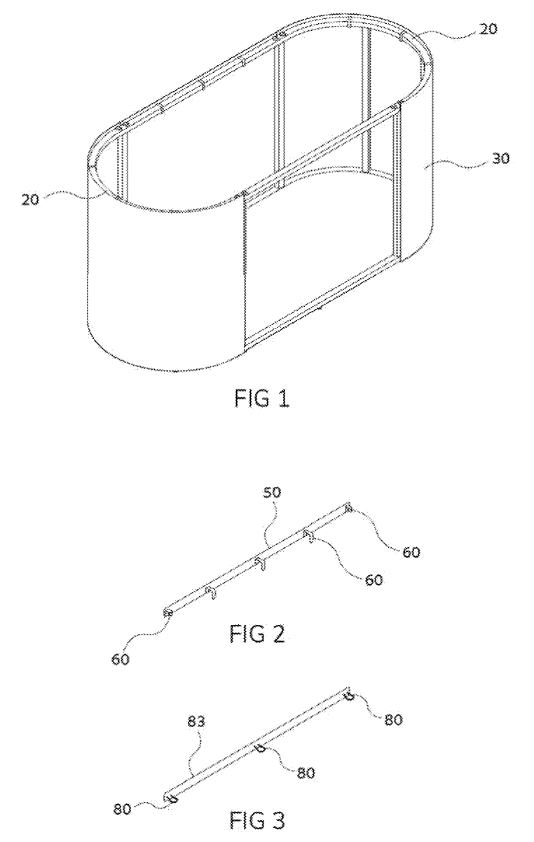

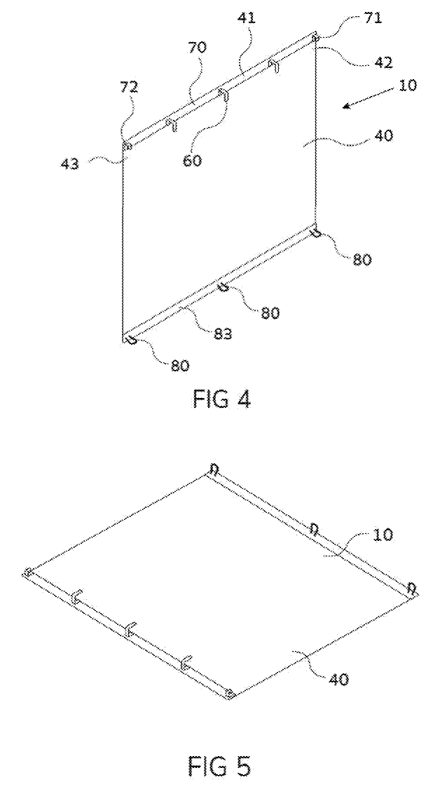

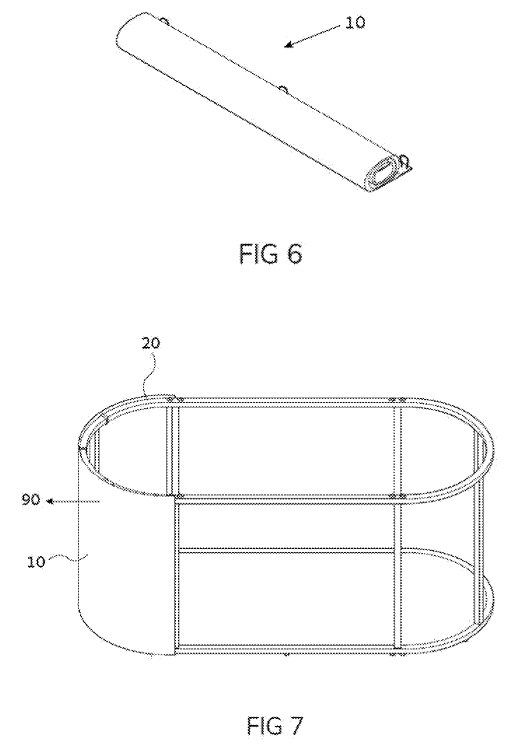

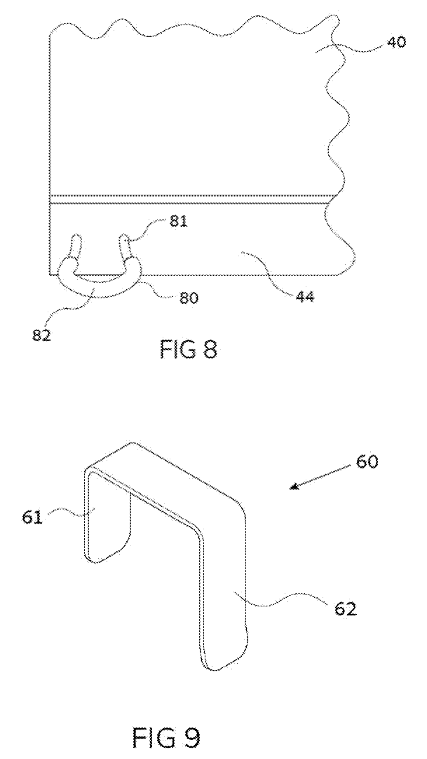

### THE INVENTION

The main object of the present invention is to provide a method for achieving a smooth, wrinkle-free appearance of a fabric cover (10) when applied to a curved frame (20) of furniture (30).

### The method comprises the following steps:

First, a self-tensioning cover assembly is provided. This assembly includes a sheet of fabric (40) having a sleeve (70) along its upper side (41), into which a spring steel strip (50) is pre-inserted. The spring steel strip is characterized by a natural physical bias toward a straight configuration. While the sleeve (70) is the preferred embodiment, equivalent means such as loops or straps configured to hold the strip may be used.

Second, the method involves connecting the upper portion of the assembly to the curved frame (20). This is achieved by securing the sleeve (70) or the spring steel strip (50) to the frame via upper connecting means (60). These means may include hooks, loops, strings, or rubber bands.

Third, the bottom portion of the fabric sheet is connected to a lower part of the frame (20) using bottom connecting means (80). This creates a fixed vertical boundary for the fabric.

### The Physics of the Method (Distinction from Prior Art):

Once the assembly is secured to the curved frame, a unique mechanical interaction occurs. Unlike prior art systems that rely on elastic contraction (which would pull the fabric closer to the frame), the present method utilizes the potential energy stored in the deformed spring steel strip.

As the spring steel strip (50) is forced to follow the arcuate shape of the frame (20), it exerts a continuous outward force (marked with arrow 90) as it attempts to return to its natural, straight configuration. Because the strip is housed within the sleeve (70) of the fabric, this "straightening" force pushes the upper edge of the fabric cover away from the curvature of the frame.

This mechanical interference between the straight bias of the strip and the curved geometry of the frame ensures that the fabric is laid flat, straight, and smooth. The resulting aesthetic is a smooth rounded shape, which is achieved regardless of any irregularities or lack of smoothness in the underlying curved frame (20).

This method is particularly advantageous in the catering furniture industry, where fabric covers must be removed, washed, and re-assembled quickly. The method allows for rapid installation while guaranteeing a high-end, tensioned appearance every time, without the need for manual stretching or complex fastening systems.

The method may further comprise the use of two or more bottom connecting means (80) to secure the lower boundary of the cover. A first side (81) of each bottom connecting means is secured to a bottom side (44) of the sheet of fabric, while a second side (82) is configured to be coupled to the curved frame (20), either directly or via an intermediate fastener such as a nut or anchor.

The bottom connecting means (80) may be selected from a group comprising hooks, elastic bands, loops, tying strings, or similar fastening elements. To ensure uniform tension across the base of the fabric, the sheet of fabric (40) may include a structural bottom strip (83) disposed along its bottom side (44), providing a reinforced attachment point for the bottom connecting means (80). This secondary anchoring point works in tandem with the outward force of the spring steel strip (50) to create a multi-axis tensioning effect, ensuring the fabric remains taut and stable.

In a preferred embodiment, the sheet of fabric (40) defines a polygonal geometry, such as a four-sided shape. Along its upper side (41), the fabric includes a sleeve (70) featuring a first opening (71) at a first corner (42) and a second opening (72) at an opposite second corner (43). The spring steel strip (50) is disposed within said sleeve (70), extending substantially from end to end to provide a continuous straightening bias across the upper width of the fabric. It is noted that the term 'sleeve' as used herein encompasses functionally equivalent structures, such as a series of loops or straps through which the strip may be threaded, similar to a belt-loop configuration. While the sheet is primarily described as being made of fabric, it may be constructed from any variety of flexible materials suitable for furniture cladding and upholstery.

The upper connecting means (60) serve as the primary interface between the tensioning assembly and the furniture. A first side (61) of the upper connecting means (60) is secured to either the sleeve (70) or directly to the spring steel strip (50) housed therein. A second side (62) of the upper connecting means (60) is configured to be coupled to, or suspended from, the curved frame (20). The upper connecting means (60) may comprise a hook, a loop, a tying string, an elastic band, or any similar fastening element capable of maintaining the assembly in position against the frame."

What is claimed is:

1. A method for smoothing and tensioning a fabric cover over a curved furniture frame, the method comprising:
providing a self-tensioning cover assembly comprising a sheet of fabric with a sleeve along an upper side thereof and a spring steel strip pre-inserted inside said sleeve, the spring steel strip having a natural bias toward a straight configuration;
connecting the sleeve or the spring steel strip of the assembly to a first portion of a curved furniture frame via upper connecting means;
connecting a bottom portion of the sheet of fabric to a second portion of the curved furniture frame; and
allowing the spring steel strip to exert an outward force as it attempts to return to its natural straight configuration against the curvature of the frame, thereby tensioning the sheet of fabric away from the curved furniture frame;
whereby the interaction between the straight bias of the spring steel strip and the arcuate shape of the frame eliminates wrinkles and maintains the fabric in a smooth, tensioned state.

2. The method of claim 1, wherein the step of connecting the bottom portion of the sheet of fabric includes utilizing bottom connecting means to secure the fabric to a lower part of the curved furniture frame.

3. The method of claim 1, wherein the curved furniture frame is part of a catering furniture item, and the method is used to provide a decorative and functional cover therefor.

4. The method of claim 1, further comprising the step of selecting a spring steel strip with a spring constant sufficient to overcome the resistance of the fabric weight, thereby ensuring the sleeve is continuously tensioned away from the curved frame.
